(19) United States
(12) Patent Application Publication
(10) Pub. No.: US 2009/0127343 A1
(43) Pub. Date: May 21, 2009

(54) Scan module support and electronic device thereof

(76) Inventor: Chin-Chang Chiang, Jhonghe City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/984,558

(22) Filed: Nov. 20, 2007

(51) Int. Cl. G06K 7/10

(52) U.S. Cl. 235/462.43

(57) ABSTRACT

A scan module support and an electronic device thereof are disclosed. The scan module support which is used for carrying a scan module includes a first accommodating space and a second accommodating space, wherein when the scan module is fixed in the first accommodating space, the scan module radiates light along a first direction and when the scan module is fixed in the second accommodating space, the scan module radiates along a second direction, and the first direction and the second direction have an overlapping angle. Thus, different scan modules can be exchanged and installed on the scan module support.

### BACKGROUND OF THE INVENTION

1. Field of the Invention

The present application is related to a scan module support, i.e. to a support structure capable of carrying a scan module, and an electronic device using said scan module support.

2. Description of Related Art

Currently, electronic devices with scanning function may include a scan module thereinside and a support for carrying the scan module. The conventional support can only cooperate with one single scan module and cannot easily adapted, so that if in one product there are two different scan modules installed for exchange, then the only solution is employing two kinds of supports, and thus, when exchanging the scan module, the original support has to be taken apart and the other must be installed into the electronic device for mounting the other scan module. Therefore, no matter for manufacturing or installation, the process is complicated and the cost is also high.

Consequently, the applicant through experience and research has developed the present application, which can effectively improve the defects described above.

### SUMMARY OF THE INVENTION

The object of the present application is to provide a scan module support which can adapt to different scan modules for exchange.

For achieving the object described above, the present application provides a scan module support for carrying a scan module, including a first accommodating space and a second accommodating space, wherein when the scan module is fixed in the first accommodating space, the scan module radiates light along a first direction and when the scan module is fixed in the second accommodating space, the scan module radiates along a second direction, and the first direction and the second direction have an overlapping angle.

The present application also provides an electronic device including a LENS, and a scan module support, adjacent to the LENS, for carrying a scan module. The scan module support has a first accommodating space and a second accommodating space, wherein when the scan module is fixed in the first accommodating space, the scan module radiates light along a first direction and when the scan module is fixed in the second accommodating space, the scan module radiates along a second direction, and the first direction and the second direction have an overlapping angle.

The present application has the advantages that: the scan module support according to the present application can be installed in an electronic device for providing multiple accommodating spaces at different positions to mount different scan modules, so that the different scan modules can be exchanged directly on the present application, and after exchanging the scan module, the preset LENS also can be used for the different scan modules, so that there is no need to manufacture different supports for different scan modules, thereby facilitating the exchange and installation of the scan module and also reducing the cost.

### BRIEF DESCRIPTION OF THE DRAWINGS

The foregoing aspects and many of the attendant advantages of this application will be more readily appreciated as the same becomes better understood by reference to the following detailed description, when taken in conjunction with the accompanying drawings, wherein:

FIG. 1 is a three-dimensional view showing the disassembly of the present application and a first scan module;

FIG. 2 is another three-dimensional view showing the present application;

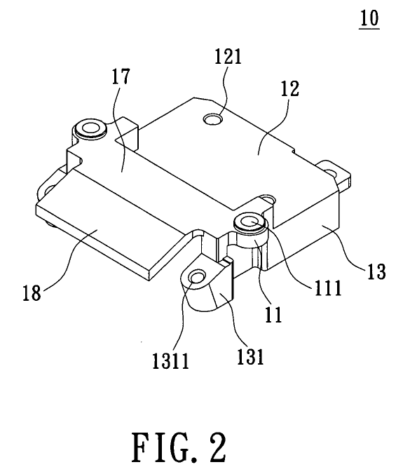

FIG. 3 is a sectional view showing the present application;

FIG. 4 is a three-dimensional view showing the assembly of the present application with the first scan module;

FIG. 5 is a side view showing the assembly of the present application with the first scan module;

FIG. 6 is a three-dimensional view showing the disassembly of the present application and a second scan module;

FIG. 7 is a three-dimensional view showing the assembly of the present application with the second scan module; and

FIG. 8 is a side view showing the assembly of the present application with the second scan module.

### DETAILED DESCRIPTION OF PREFERRED EMBODIMENTS

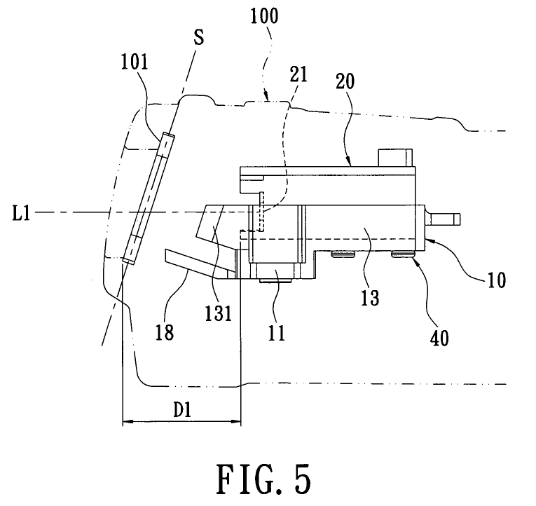

The scan module support of the present application is related to an electronic device 100 (please refer to FIG. 5). The electronic device 100 can be a personal digital assistant (PDA), an industrial digital assistant, a bar-code scanner, a mobile phone, a portable PC, the point of sale (POS) system or a notebook. In this embodiment, the electronic device 100 is an industrial barcode scanner having a LENS 101 mounted therein, wherein the LENS 101 is flat and is made of transparent material, and the LENS 101 is mounted in the electronic device 100 along a tilted direction S.

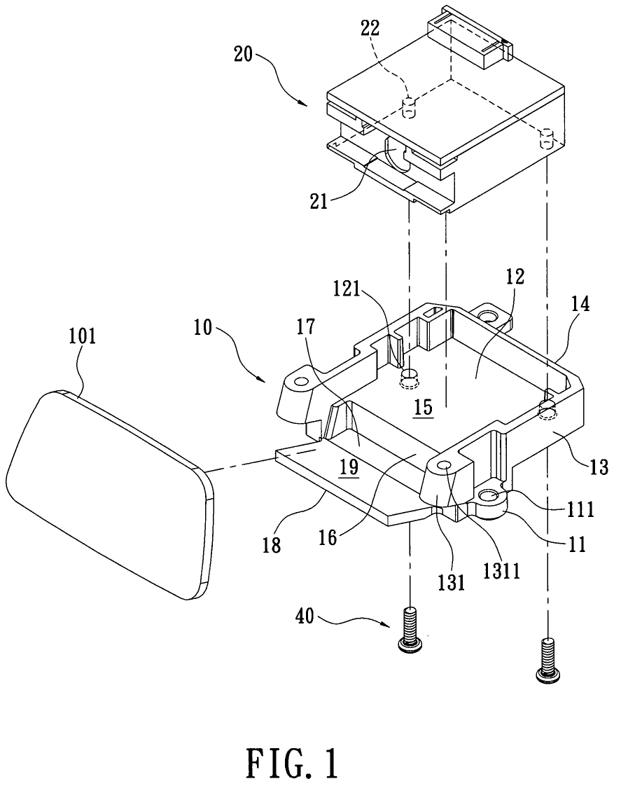

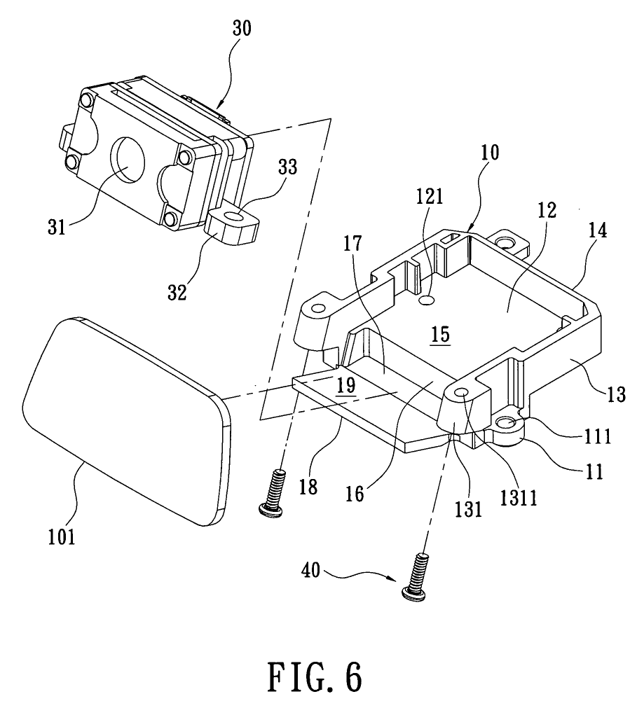

The scan module support is adjacent to the LENS 101 and is used for mounting a first scan module 20 (please refer to FIG. 1) or a second scan module 30 (please refer to FIG. 6). In the preferred embodiment, the first scan module 20 can be a 1D barcode scan module, but is not limited thereto. A first lens 21 is mounted near the front end of the first scan module 20, and thus, the first scan module 20 may radiate the light through the first lens 21 along the first direction L1 (please refer FIG. 5). Besides, the bottom of the first scan module 20 further has two locking holes 22 mounted thereon for fixing.

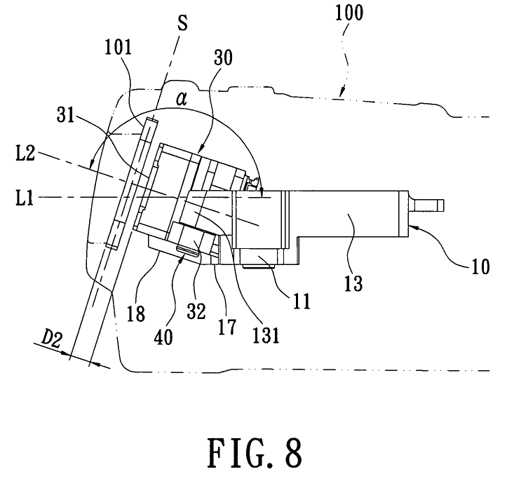

Please refer to FIG. 6, in this embodiment, the second scan module 30 can be a 2D barcode scan module, but is not limited thereto. A second lens 31 is mounted near the front end of the second scan module 30, and thus, the second scan module 30 may radiate the light through the second lens 31 along the second direction L2 (please refer FIG. 8), wherein the overlapping angle between the second direction L2 and the first direction L1 is an obtuse angle α, which ranges from 130 to 195 degrees. In addition, the left and the right ends near the bottom of the second scan module 30 respectively have a flank 32 outwardly protruding thereon, and each flank 32 has a through hole 33 for fixing the second scan module 30.

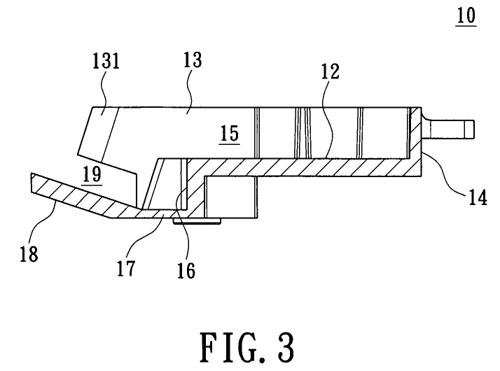

Please refer to FIG. 1 and FIG. 3, the scan module support includes a main body 10, which has an approximately rectangular shape, wherein the main body 10 has plural fixing portions 11 mounted at the edge thereof and the fixing portions 11 respectively have a through hole 11 mounted thereon for fixing the main body 10 inside the electronic device 100.

The rear portion of the main body 10 has a first bottom wall 12 parallel to the first direction L1 (as shown in FIG. 5), and the right and the left sides of the first bottom wall 12 are upwardly extended to form a side wall 13 respectively and the rear side of the first bottom wall 12 is upwardly extended to form a real wall 14. The first bottom wall 12, the two side walls 13 and the rear wall 14 together define a first accommodating space 15 with a front end opening. Here, the first accommodating space 15 is located at the rear portion of the main body 10 for placing the first scan module 20. Besides, the first bottom wall 12 which is located below the first accommodating space 15 has two fixing holes 121 corresponding to the two locking holes 22 of the first scan module 20.

Please further refer to FIG. 3. The front end of the first bottom wall 12 is downwardly extended to form a front wall 16, and the front end of the front wall 16 is forwardly extended to form an extension wall 17. Then, the front end of the extension wall 17 is upwardly extended along the second direction L2 (as shown in FIG. 8) to form a second bottom wall 18, so that the second bottom wall 18 is titled to the first bottom wall 12.

The top portions of the front ends of the two side walls 13 respectively have an installation portion 131 outwardly protruding thereon, and the two installation portions 131 are located above the second bottom wall 18 apart a distance. The two installation portions 131 and the second bottom wall 18 together define a second accommodating space 19 in font of the main body 10 for placing the second scan module 30, and the second bottom wall 18 is located below the second accommodating space 19. Moreover, the two installation portions 131 are respectively located two the right and the left sides of the second accommodating space 19 and respectively have an installation hole 1311 corresponding to the through hole 33 of the second scan module 30.

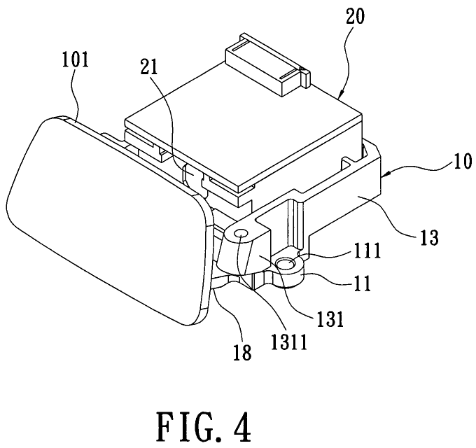

Please refer to FIG. 4 and FIG. 5. When the user wants to use the first scan module 20 in the electronic device 100, he or she only needs to place the first scan module 20 in the first accommodating space 15 of the main body 10 and screw two screws 40 in the two locking holes 22 of the first scan module 20 through penetrating the two fixing holes 121 of the first bottom wall 12, and then, the first scan module 20 can be fixedly installed on the main body 10. Therefore, the direction of light radiation of the first scan module 20 (namely, the first direction L1) is titled to the direction of the LENS 101 (namely, the titled direction S), and the first scan module 20 and the LENS 101 have an interval D1 ranging between 8.5 mm and 12 mm (please refer FIG. 5), so that the first scan module 20 and the LENS 101 of the electronic device 100 can be cooperated to perform the 1D barcode scanning function.

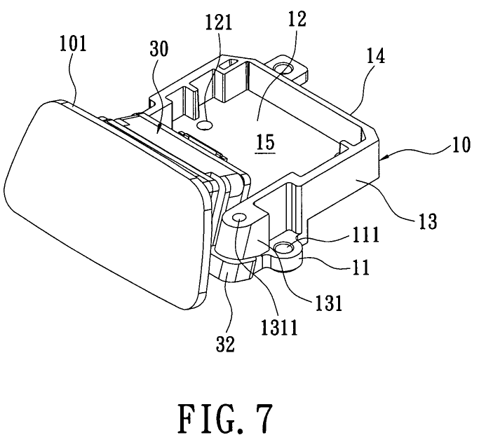

Please refer to FIG. 6 to FIG. 8. When the user wants to use the second scan module 30 in the electronic device 100, he or she only needs to place the second scan module 30 in the second accommodating space 19 of the main body 10, correspondingly reject the two flanks 32 of the second scan module 30 to the bottom of the two installation portions 131 of the main body 10, and screw two screws 40 into the two installation holes 1311 of the two installation portions 121 through penetrating the through holes 33 of the second scan module 30, and then, the second scan module 30 can be fixedly installed on the main body 10. Therefore, the direction of light radiation of the second scan module 30 (namely, the second direction L2) is perpendicular to the direction of the LENS 101 (namely, the titled direction S), and the second scan module 30 and the LENS 101 have an interval D2 ranging between 1.5 mm and 3.0 mm (please refer FIG. 8), so that the second scan module 30 and the LENS 101 of the electronic device 100 can be cooperated to perform the 1D barcode scanning function.

As above, in the embodiment, the first scan module 20 and the second scan module 30 are fixed by screw, but are not limited thereto.

In the aforesaid, the scan module support of the present application is formed to have multiple accommodating spaces for placing different scan modules for exchange, so that one single support can be used to install different scan module, which achieves a higher adaptation, thereby the user can change the scan module according to the demand. When exchanging the scan module, the user does not need to take original support in the electronic device apart, and only needs to take out the original scan module and reinstall another scan module into the other accommodating space, thereby achieving an easy and convenient installation. Besides, after exchanging the scan module, the scan module can directly be used without altering the position of the LENS.

In addition, since there is no need to manufacture different support for different scan module, only one mold is needed and the cost can also be saved.

It is to be understood, however, that even though numerous characteristics and advantages of the present application have been set forth in the foregoing description, together with details of the structure and function of the application, the disclosure is illustrative only, and changes may be made in detail, especially in matters of shape, size, and arrangement of parts within the principles of the application to the full extent indicated by the broad general meaning of the terms in which the appended claims are expressed.

What is claimed is:

1. A scan module support for carrying a scan module, comprising a first accommodating space and a second accommodating space, wherein when the scan module is fixed in the first accommodating space, the scan module radiates light along a first direction and when the scan module is fixed in the second accommodating space, the scan module radiates along a second direction, and the first direction and the second direction have an overlapping angle.

2. The scan module support as claimed in claim 1, wherein the first accommodating space and the second accommodating space respectively have a first bottom wall and a second bottom wall therebelow, and the first bottom wall is parallel to the first direction and the second bottom wall is parallel to the second direction.

3. The scan module support as claimed in claim 1, wherein the overlapping angle ranges from 130 to 195 degrees.

4. The scan module support as claimed in claim 1, wherein the scan module is a 1D barcode scan module.

5. The scan module support as claimed in claim 1, wherein the scan module is a 2D barcode module.

6. An electronic device, comprising:
a LENS; and
a scan module support, adjacent to the LENS, for carrying a scan module, which has a first accommodating space and a second accommodating space, wherein when the scan module is fixed in the first accommodating space, the scan module radiates light along a first direction and when the scan module is fixed in the second accommodating space, the scan module radiates along a second direction, and the first direction and the second direction have an overlapping angle.

7. The electronic device as claimed in claim 6, wherein when the scan module is disposed in the first accommodating space, an interval ranging from 8.5 mm to 12 mm is located between the scan module and the LENS.

8. The electronic device as claimed in claim 6, wherein when the scan module is disposed in the second accommodating space, an interval ranging from 1.5 mm to 3.0 mm is located between the scan module and the LENS.

9. The electronic device as claimed in claim 6, wherein the scan module is a 1D barcode scan module.

10. The electronic device as claimed in claim 6, wherein the scan module is a 2D barcode module.
